(19) United States
(12) Patent Application Publication
(10) Pub. No.: US 2009/0111625 A1
(43) Pub. Date: Apr. 30, 2009

(54) BICYCLE GEARSHIFT

(75) Inventors: Maurizio Valle, Vicenza (IT); Paolo Pasqua, Vicenza (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.R.I., Vicenza (IT)

(21) Appl. No.: 12/251,807

(22) Filed: Oct. 15, 2008

(30) Foreign Application Priority Data
Oct. 25, 2007 (IT) MI2007A002062

(51) Int. Cl. F16H 59/04

(52) U.S. Cl. 474/80; 474/82

(57) ABSTRACT

The disclosed bicycle gearshift (20) includes a support member (22) configured for mounting on a bicycle frame, a driving member (24) for driving of a bicycle chain, and at least one articulation arm (28) to movably connect the driving member (24) to the support member (22). The articulation arm (28) is connected to at least one portion of the support member (22) and the driving member (24) so that it can rotate about a respective rotational axis (30a) through at least one respective connecting pin (40a) extending along the rotational axis (30a). At least one first rolling element (54) is operatively arranged in the radial direction between the connecting pin (40a), one of the articulation arms (28), the portion of the support member (22), and the driving member (24).

### FIELD OF INVENTION

The present disclosure relates to a bicycle gearshift. The disclosure also relates to a bicycle including the aforementioned gearshift. Preferably, the bicycle is a racing bicycle and the gearshift is a motorized gearshift.

### BACKGROUND

A bicycle is a mechanical vehicle moved by muscular driving force that is transmitted to a rear driving wheel through a motion transmission system. The motion transmission system includes a pair of crank arms, on which the cyclist exerts a propulsive thrust, one or more driving sprockets, rotated by direct coupling with the crank arms, and one or more driven sprockets, rotated by the driving sprockets through a chain, the driven sprockets being coupled with the hub of the rear wheel.

In particular, racing bicycles include a plurality of driven sprockets of various diameters and a plurality of driving sprockets, also of various diameters. The chain simultaneously engages a driving sprocket and a driven sprocket and is selectively movable over them through a front gearshift and a rear gearshift, so as to obtain the combination of a particular driving sprocket and driven sprocket that offers the most favorable transmission ratio for the conditions of the route.

The front gearshift is mounted on the seat post tube of the bicycle frame near the plurality of driving sprockets and moves the chain from one driving sprocket to another. The rear gearshift is mounted on a portion of the bicycle frame adjacent to the plurality of driven sprockets and moves the chain from one driven sprocket to another.

In the prior art, the front and rear gearshifts are made according to an articulated quadrilateral arrangement formed by a support member that remains fixed with respect to the frame, a chain driving member, typically known as chain guide, and a pair of articulation arms to movably connect the chain guide to the support member. Each articulation arm is rotatably connected to the support member and the chain guide through respective pins inserted in respective holes. The pins are generally fixed to the support member and the chain guide, and the holes are defined in the articulation arm. The pin-hole couplings are provided with specific clearances in order to permit relative rotation.

The actuation of the gearshift can be manual or motorized.

In manually-actuated gearshifts, the chain guide is generally connected to a control cable that is pulled by the cyclist to move the chain guide in a predetermined direction, generally away from the longitudinal central plane of the bicycle, towards the driving sprockets of smaller diameters. The chain guide is moved in the opposite direction by a counteracting spring that bears on the chain guide when the cable is loosened. The balance between tension of the cable and the force of the spring keeps the chain guide in a stable position upon a desired sprocket.

The spring also has the further effect of keeping the components of the articulated quadrilateral in abutment with one another, eliminating the clearances between them. This is necessary since a clearance, even a small one, close to the support member, would be amplified due to the length of the articulation arms until a substantial positioning error of the chain guide were generated. The aforementioned spring therefore makes it possible to ensure sufficient precision in gearshifting.

### SUMMARY

The present disclosure relates to a bicycle gearshift that includes a support member that is configured to be mounted on a bicycle frame, a driving member that drives a bicycle chain, and at least one articulation arm to movably connect the driving member to the support member. The support member, driving member, and the articulation arms are attached by connecting pins associated with respective rotational axes to form an articulated quadrilateral. The gearshift also includes at least one rolling element that is mounted at a radially outer position with respect to a connecting pin.

### BRIEF DESCRIPTION OF THE DRAWINGS

FIG. 1 schematically shows a perspective view of the disclosed bicycle gearshift;

FIG. 2 schematically shows an exploded view of the bicycle gearshift of FIG. 1;

FIG. 3 schematically shows a front elevational view of the gearshift of FIG. 1;

FIG. 4 schematically shows a sectional view of the gearshift of FIG. 3, taken according to the plane traced with line IV-IV of FIG. 3;

FIG. 5 schematically shows an enlarged detail of the view of FIG. 4;

FIGS. 5A and 6-12 schematically show further embodiments of the gearshift, in respective views analogous to that of FIG. 5.

### DETAILED DESCRIPTION OF THE PREFERRED EMBODIMENTS

### Introduction to the Embodiments

The present disclosure relates, in a first aspect thereof, to a bicycle gearshift that includes a support member configured for mounting on a bicycle frame, a driving member of a bicycle chain, and at least one articulation arm to movably connect the driving member to the support member, the articulation arm being connected to at least one portion of the support member and the driving member so that it can rotate around a respective rotational axis through at least one respective connecting pin extending along the rotational axis. The gearshift further includes at least one first rolling element operatively arranged in the radial direction between the connecting pin, one of the articulation arms, the portion of the support member connected to the articulation arm, and the driving member.

Throughout the present description and in the subsequent claims, by “rolling element” it is meant any element that can rotate around at least one rotational axis. For example, such an element can be a ball, a cylinder or a cone. Moreover, throughout the present description and in the subsequent claims, by “radial direction” it is meant a direction substantially perpendicular to the rotational axis of the connecting pin between articulation arm and support member or driving member, whereas by “axial direction” it is meant a direction substantially parallel to the aforementioned rotational axis.

The interposition in the radial direction of a rolling element between the connecting pin of the articulation arm and the support member and/or between the connecting pin of the articulation arm and the driving member ensures that the friction caused by rotation of the articulation arm with respect to the support member and/or the driving member is reduced with respect to that of the pin-hole coupling of the prior art, since the gearshift includes a rolling contact instead of sliding contact.

The use of the rolling element allows the radial clearance between the articulation arm and the support or driving member to be eliminated. An optimal operating condition is created that gives the cyclist an immediate feeling of operation that is precise, due to the absence of clearance, as well as fast and light, due to the low friction. Moreover, with the disclosed gearshift, risks of jamming or delay in gearshifting, due to difficulties of relative rotation between the articulation arm and the support member and/or the driving member are also avoided.

In one embodiment of the gearshift, the connecting pin is associated with the support member and/or the driving member, and the rolling element is arranged between the connecting pin and the articulation arm.

In this embodiment, the connecting pin can be formed as one piece with the support member and/or driving member, or alternatively, it can be removably associated with the support member and/or the driving member.

In a further embodiment of the gearshift, the connecting pin is associated with the articulation arm, and the rolling element is arranged between the connecting pin and the support member and/or the driving member.

In this embodiment, the connecting pin can be formed as one piece with the support member and/or the driving member, or alternatively, it can be removably associated with the support member and/or the driving member.

Preferably, the articulation arm and the support member and/or the driving member rest directly on one another in the axial direction. This eliminates the axial clearance that may have existed because the resting in the radial direction is carried out through the aforementioned rolling element.

This configuration creates a state of particularly low friction. Due to the main driving direction of the gearshift on the chain, the load in the articulation points, especially in the case of an articulated quadrilateral arrangement, is mostly radial with respect to the rotational axes of the components in relative motion. This minimizes axial loads so that even in the worst conditions of contact, there is low friction in the axial direction.

More preferably, the articulation arm and the support member and/or the driving member rest on one another in the axial direction through the interposition of at least one second rolling element.

In this embodiment, friction in the axial direction is avoided, so that the risk of jamming or slowing down gearshifting is drastically reduced.

In one preferred embodiment, the gearshift comprises at least one setting device to exert a preloading force in the axial direction on the articulation arm, the support member, and/or the driving member.

Due to this configuration, it is possible to completely recover axial clearances because the rolling element acts in the radial direction when the two components of the gearshift move in relative rotation, i.e. when the articulation arm and the support member or the articulation arm and the driving member are moving towards or away from one other.

Preferably, the gearshift also includes at least one elastic element operatively arranged between the articulation arm and the support member and/or the driving member, to exert a biasing force in the axial direction.

The elastic element allows the preloading thrust on the components of the gearshift in relative rotation to be better adjusted and allows early wearing of the relative coupling or jamming in rotation to be avoided.

The position of the aforementioned elastic element can vary. In particular, the aforementioned elastic element can be arranged between the rolling element acting in the radial direction and the articulation arm, or between the rolling element acting in the radial direction, and the support member and/or the driving member.

In the embodiment in which the rolling element acting in the axial direction is also provided, the elastic element can be arranged between the rolling element acting in the radial direction and the rolling element acting in the axial direction, or between the rolling element acting in the axial direction and the articulation arm, or alternatively between the rolling element acting in the axial direction and the support member and/or the driving member.

Preferably, the aforementioned elastic element is a disc spring, but may comprise other elastic means capable of performing the same function, such as a rubber pad.

In another preferred embodiment of the gearshift, the connecting pin is rigidly fixed to the support member and/or to the driving member.

In this embodiment, the connecting pin can be screwed into a threaded cavity of the support member and/or the driving member, or alternatively, for example when the component onto which the pin has to be screwed is made from composite material, in a threaded cavity of a metallic insert associated with the support member and/or the driving member.

Due to this configuration, the mutual axial position between connecting pin and support member and/or driving member (or between connecting pin and insert) is adjustable through screwing of the pin in the cavity in the support member and in the driving member (or in the insert).

In a preferred embodiment of the gearshift, the rolling element acting in the radial direction is in a radial bearing.

In the embodiment in which the gearshift comprises a radial bearing, it has an inner ring fitted onto the connecting pin and an outer ring in contact with the inside of a cavity formed in the articulation arm, support member and/or driving member.

Preferably, the connecting pin has a head in axial abutment with the inner ring of the radial bearing.

In this way the connecting pin, through its screwing into the cavity provided on the articulation arm or on the support member and/or driving member, acts as a setting device to exert the preloading force in the axial direction on the articulation arm and on the support member and/or driving member.

Indeed, during screwing of the pin, the two components of the gearshift connected through the pin are pulled towards one another until they abut. Further screwing of the pin creates a load on the radial bearing and completely eliminates the axial clearances.

In the embodiment in which the rolling element acting in the axial direction is also provided, it is preferably part of an axial bearing.

More preferably, the axial bearing is operatively arranged between the outer ring of the radial bearing and the articulation arm or the support member and/or driving member.

Even more preferably, the axial bearing has a first ring adjacent to the radial bearing. The first ring is preferably mounted with clearance displacing it from the connecting pin. A second ring opposite the first ring is mounted with clearance displacing it from the articulation arm or the support member and/or driving member.

This configuration avoids sliding contacts between the components in relative rotation, therefore avoiding friction.

In a further embodiment of the gearshift, the rolling element acting in the radial direction and the rolling element acting in the axial direction are included in a single bearing having a double row of rolling elements.

In a further embodiment thereof, the gearshift comprises circumferential pathways defined in the connecting pin and the articulation arm or in the support member and/or driving member to permit rolling of the rolling element acting in the radial direction.

In addition or alternatively, the gearshift also comprises further circumferential pathways defined in the articulation arm and on the support member and/or driving member to permit rolling of the rolling element acting in the axial direction.

In a preferred embodiment thereof, the gearshift comprises two articulation arms and the rolling element acting in the radial direction is coupled with the articulation arm which is closest to the bicycle frame when the gearshift is associated with the frame.

Preferably, the rolling element is coupled with the articulation arm at a portion of the articulation arm which is axially farthest away from the driving portion of the driving member of the bicycle chain.

In this way, the point of articulation between support member and articulation arm where the rolling element acting in the radial direction is provided is the one which is farthest away from the driving portion of the driving member of the chain, making a recovery of the clearance in this point of articulation particularly advantageous for the correct positioning of the driving member, thus permitting a high precision of gearshifting to be achieved.

Preferably, the gearshift is a motorized gearshift.

In a second aspect thereof, the present disclosure relates to a bicycle comprising a gearshift of the type described above.

Preferably, such a bicycle has, individually or in combination, all of the structural and functional characteristics discussed above with reference to the aforementioned gearshift, and therefore has all of the aforementioned advantages.

Further characteristics and advantages of the gearshift shall become clearer from the following detailed description of some preferred embodiments thereof, made with reference to the attached drawings and given for exemplary and not limiting purposes.

### DETAILED DESCRIPTION

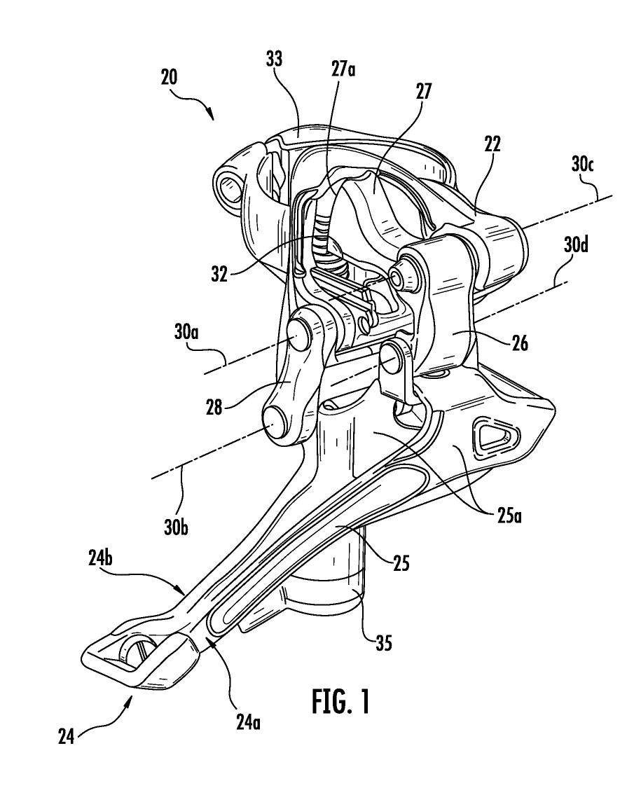

Initially with reference to FIGS. 1-5, a first embodiment of a bicycle gearshift, in particular a front gearshift, is shown, wholly indicated with 20.

The gearshift 20 includes a support member 22, configured to be fixed to the seat post tube (not illustrated) of a bicycle frame, a driving member 24 configured to act by driving the chain of a bicycle (not shown) to move it from a position of engagement with one driving sprocket to another driving sprocket (not shown), and having a forked shape, a front articulation arm 26, and a rear articulation arm 28, the front articulation arm 26 being located farther from the central plane of the bicycle frame than the rear articulation arm 28. The two articulation arms 28 and 26 are rotatably connected to the support member 22 and the driving member 24 about four articulation axes 30a, 30b, 30c and 30d, respectively, according to an articulated quadrilateral arrangement.

The driving member 24 is substantially shaped like a fork, is arranged substantially parallel to the central plane of the bicycle frame, and extends towards the rear end of the bicycle. The driving member 24 includes two plates, front and rear 24a, 24b, the front plate 24a being farther from the central plane of the bicycle frame than the rear plate 24b. The front plate 24a includes a driving portion 25 for driving movement of the chain, arranged either in a central area or near the end of the plate located towards the rear of the bicycle, with respect to the area 25a of connection with the two articulation arms 26 and 28.

The support member 22 preferably includes a fastening clip 33 configured to lock around the seat post tube of the bicycle frame. The support member 22 can be made from any material, such as an aluminum alloy, a composite material or a polymer.

By composite material what is meant is a material consisting of at least two components including a polymeric matrix and filler such as structural fibers, granules or powders. Where structural fibers are used, they are preferably selected from the group consisting of carbon fibers, glass fibers, aramid fibers, ceramic fibers, boron fibers and combinations thereof. Carbon fibers are particularly preferred. Preferably, the polymeric material is thermosetting and comprises an epoxy resin. However, the use of a thermoplastic material is not excluded.

By structural composite materials what is meant are those materials containing structural fibers having a length of over five millimeters.

By reinforced composite materials, on the other hand, what is meant is those materials comprising a polymeric matrix filled with fibers of a length less than or equal to five millimeters and/or with powders and/or with granules. The sizes shown refer to the length of the fibers found in a finished piece.

Reinforced composite materials have a structural strength lower than that of structural composite materials, are generally suitable for injection molding, and can be easily worked, which is why they are particularly preferred for manufacturing the support member 22, to which they also help to minimize the weight of. However, for such a component the use of a simple polymer is not excluded.

The rear articulation arm 28 can be made from the same material as the support member 22 or from a different material, but again is preferably made from a metallic material, such as an aluminum alloy, or a composite material.

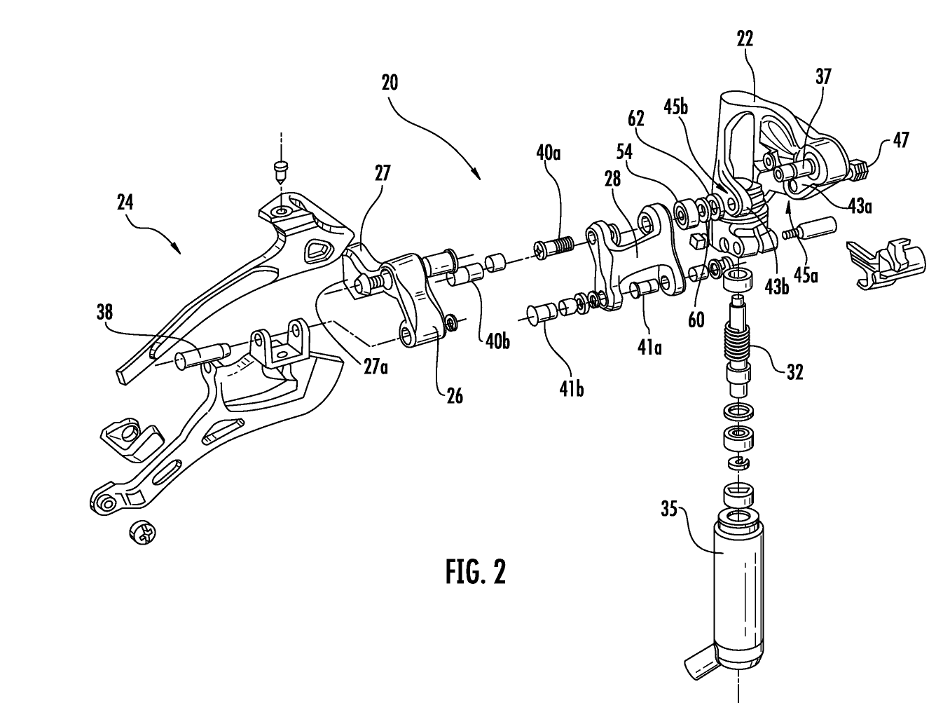

As shown more clearly in FIG. 2, the gearshift 20 is a motorized gearshift that operates according to the principles illustrated in issued U.S. Pat. No. 6,679,797, to the same Applicant, and is hereafter schematically set forth. The support member 22 has a shape adapted to house a worm screw 32 actuated by an electric motor 35. The front articulation arm 26 has an extension 27 ending in an engagement portion 27a carrying a nut that engages the worm screw 32. The worm screw 32, actuated by the electric motor 35, drives the nut to move the engagement portion 27a of the extension 27, causing the arm 26 to rotate around a connecting pin 37 coaxial with the articulation axis 30c (FIG. 1) like a lever pivoted at the aforementioned pin 37, causing the driving member 24 to move. The driving member 24 is in turn fixed to the front arm 26 through a connecting pin 38 coaxial to the articulation axis 30d.

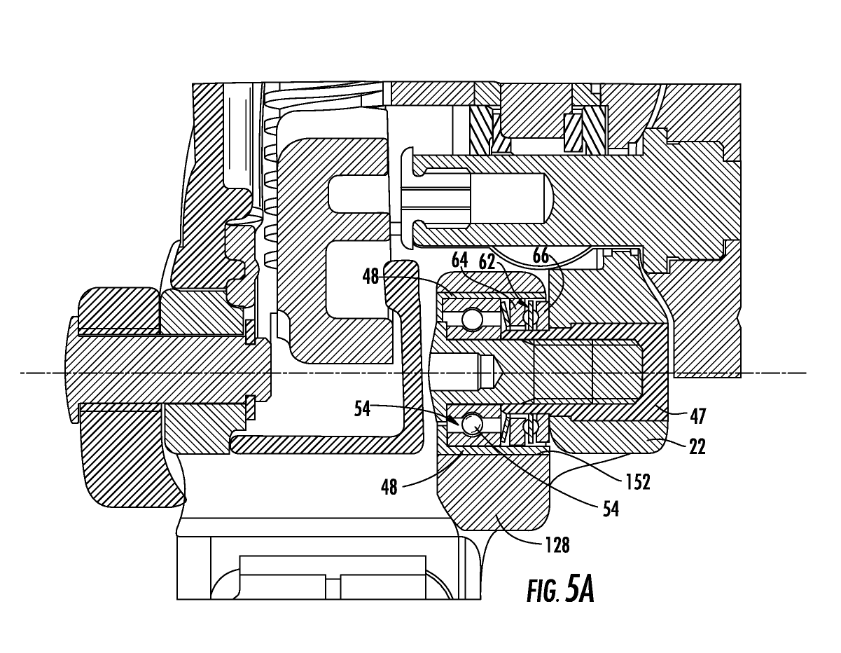

The rear articulation arm 28 limits the possible positions that the driving member 24 can take up when it moves about the articulation axis 30d. The rear articulation arm 28 is substantially H-shaped and is connected to the support member 22 so that it can rotate around the axis 30a through two coaxial connecting pins 40a and 40b. The rear articulation arm 28 is connected to the driving member 24 so that it can rotate around the axis 30b through two coaxial connecting pins 41a and 41b. The support member 22 in turn comprises two flanges 43a and 43b, where seats 45a and 45b are formed to respectively receive the pins 40a and 40b. In the embodiments in which the support member 22 is made from a composite material or a simple polymer, it is preferable to apply an insert 47 between the pin 40a and the support member 22. The insert 47 may have a substantially cylindrical shape, with a threaded cylindrical cavity 47c for receiving of the pin 40a. The insert 47 can be co-molded, glued, or simply held through a shoulder 47a, as indicated in FIG. 5. An insert of the aforementioned type can also be provided between pin 40b and the support member 22.

The pins 40a, 40b, 41a and 41b can be associated with the support member 22, or with the articulation arms 26 and 28, or some pins can be associated with the support member 22 and the others with the articulation arms 26 and 28.

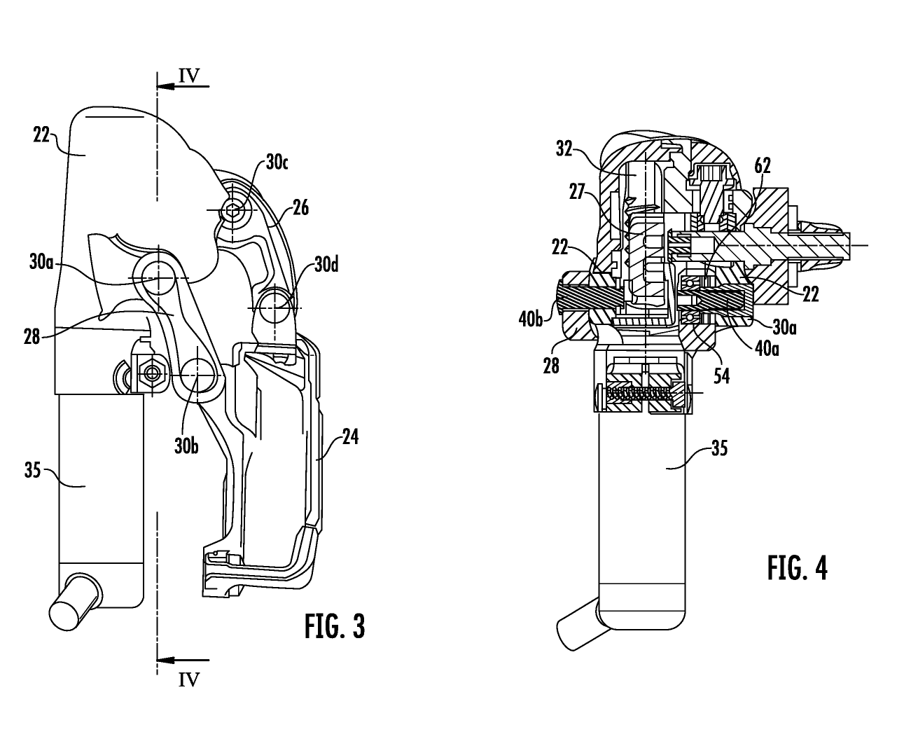

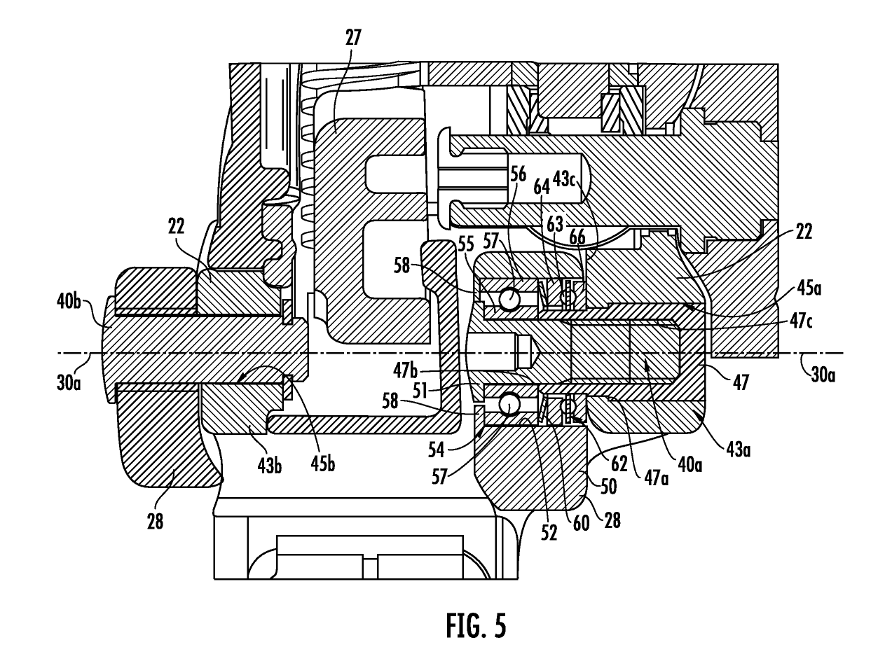

FIG. 3 shows the gearshift of FIG. 1 in a front elevation view so that the articulated quadrilateral arrangement is apparent. In this arrangement the support member 22, the driving member 24 and the two articulation arms 26 and 28 form the sides of the quadrilateral and axes 30a, 30b, 30c and 30d are the articulation axes. The section of FIG. 4, and in greater detail the enlargement of FIG. 5, show the coupling between the rear articulation arm 28 and the support member 22.

With particular reference to FIG. 5, it should be observed that the end 50 of rear articulation arm 28 defines a circular through hole 52, aligned with the seat 45a of the flange 43a of the support member 22. A radial bearing 54 is inserted with pressure in the through hole 52. In particular, the bearing 54 is inserted from the side of the through hole 52 facing the seat 45a (right side with reference to FIG. 5) until a shoulder 58 of the through hole 52 is reached. Such a direct coupling can be made in the embodiments in which the articulation arm 28 is made from metallic material.

In the embodiment of FIG. 5A, the arm 128, analogous to the arm 28 of the gearshift 20 illustrated in FIGS. 1-5, is made from composite material. In this embodiment, it is particularly advantageous to place a metallic insert 48, made from a metal such as aluminum alloy or steel, between the through hole 152 and the bearing 54.

In FIG. 5A, structural elements that are identical or equivalent from the functional point of view to those of the gearshift 20 of FIGS. 1-5 are indicated with the same reference numerals.

The insert 48 of FIG. 5A has a substantially annular shape and is glued inside a through hole 152 of the arm 128. Alternatively, the insert may be 48 co-molded with the arm 128, inside one of the through holes 152.

The radial bearing 54 has, on its left side with reference to FIG. 5, an outer ring 56 in abutment with the shoulder 58 of the through hole 52, and an inner ring 55 in abutment with a head 51 of the pin 40a, the head 51 being partially inserted in the through hole 52.

On the right side of the radial bearing 54 with reference to FIG. 5, the inner ring 55 is in abutment with a side end 47b of the insert 47 (or alternatively with the support member 22), so that it is completely immobilized with respect to the pin 40a.

A disc spring 60 and an axial bearing 62 are mounted in a radially outer position on the insert 47.

The axial bearing 62 is axially preloaded by a force determined by the depth of which the pin 40a is screwed in the insert 47, and by the bias exerted by the compression of the disc spring 60. A person of ordinary skill in the art would understand that any elastic means can be used instead of the disc spring 60, such as an elastic rubber pad.

The radial bearing 54 can comprise rolling elements of any type. In FIGS. 4 and 5, balls 57 are illustrated, but the use of cylindrical rollers or cones is not excluded. The same applies to the rolling elements 63 of the axial bearing 62.

The axial bearing 62 has the function of allowing the outer ring 56 of the radial bearing 54 to rest against the support member 22 without generating friction during rotation. In this way, the axial bearing 62 provides a support that prevents the clearances in the radial bearing 54 resulting from axial movement of the ring 56 on the rolling elements 57.

In order to operate as well as possible without adding friction, the ring 64 of the axial bearing 62 closest to the radial bearing 54 is mounted with clearance displacing it from the pin 40a (and from the insert 47), whereas the opposite ring 66 is mounted with clearance displacing it from the inner surface of the through hole 52 of the rear articulation arm 28 (alternatively, in the embodiment of FIG. 5A, the opposite ring 66 is mounted with clearance displacing it from the inner surface of the insert 48).

The ring 66 of the axial bearing 62 is mounted in abutment with the side surface 43c of the flange 43a that faces the articulation arm 28.

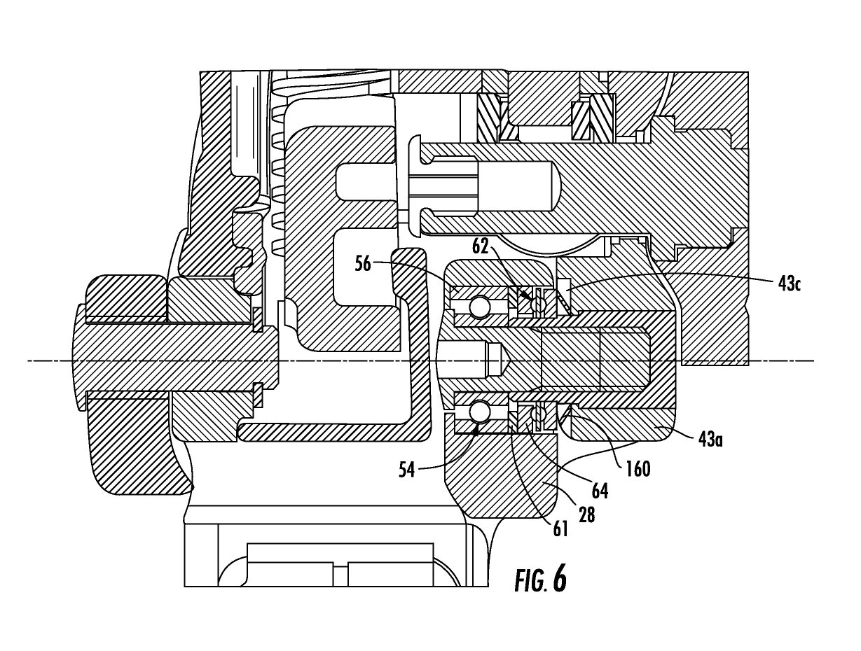

FIG. 6 shows a second embodiment of the bicycle gearshift. In this embodiment, structural elements that are identical or equivalent from the functional point of view to those of the gearshift 20 described above with reference to FIGS. 1-5 are indicated with the same reference numerals and they shall not be described any further.

This second embodiment of the gearshift differs from the first embodiment of the gearshift 20 in that the disc spring 160 is arranged between the axial bearing 62 and the support member 22, and a spacer ring 61 is arranged between the outer ring 56 of the radial bearing 54 and the ring 64 of the axial bearing 62

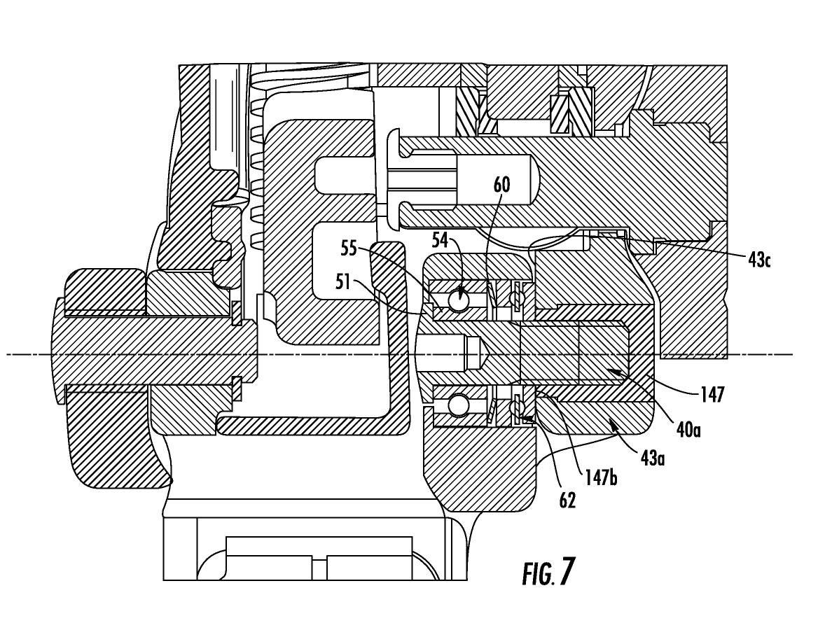

FIG. 7 shows a third embodiment of the bicycle gearshift. In this embodiment, structural elements that are identical or equivalent from the functional point of view to those of the gearshift 20 described above with reference to FIG. 1-5 shall be indicated with the same reference numerals and they shall not be described any further.

This third embodiment of the gearshift differs from the first embodiment of the gearshift 20 in that the inner ring 55 of the radial bearing 54 is not blocked between the head 51 of the pin 40a and the side end 147b of an insert 147, analogous to the insert 47 of the gearshift 20 illustrated in FIGS. 1-5. In this embodiment, however, the side end 147b of the insert 47 is aligned with the side surface 43c of the flange 43a that faces the articulation arm 28. The disc spring 60 and the axial bearing 62 are mounted in a radially outer position on the pin 40a and the ring 66 of the axial bearing 62 is mounted in abutment with the side surface 43c of the flange 43a and on the side end 147b of the insert 147. In this case, the preloading of the bearing 54 is adjusted by screwing the pin 40a in the insert 147 and by the disc spring 60.

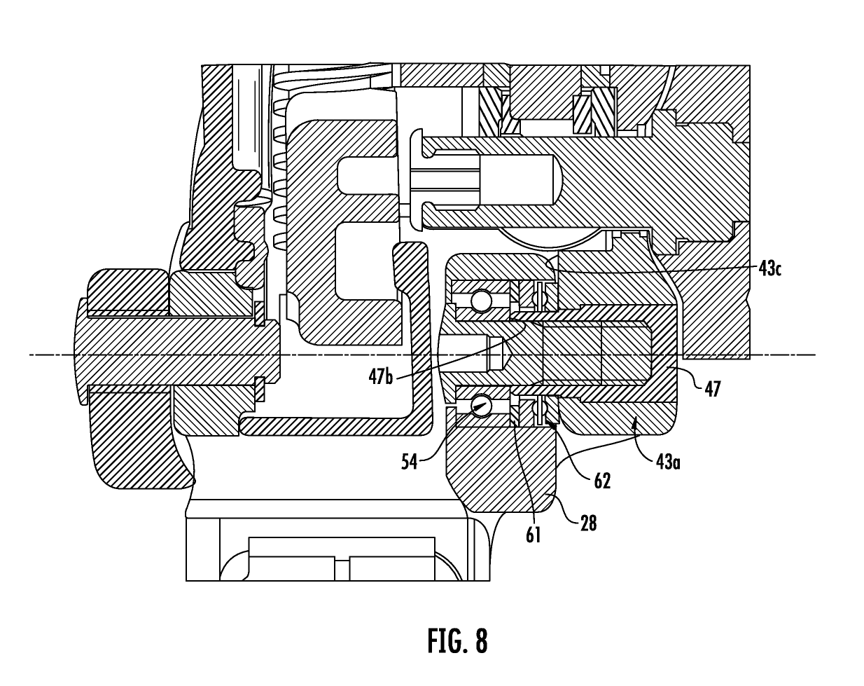

FIG. 8 shows a fourth embodiment of the bicycle gearshift. In this embodiment, structural elements that are identical or equivalent from the functional point of view to those of the gearshift 20 described above with reference to FIGS. 1-5 shall be indicated with the same reference numerals and they shall not be described any further.

This fourth embodiment of the gearshift differs from the first embodiment of the gearshift 20 in that the disc spring 60 between the radial bearing 54 and the axial bearing 62 has been omitted. Moreover, a spacer ring 61 is disposed between the outer ring 56 of the radial bearing 54 and the ring 64 of the axial bearing 62. In this embodiment it is necessary to take particular care during axial preloading, which is applied directly on the bearings 54 and 62 by screwing the pin 40a.

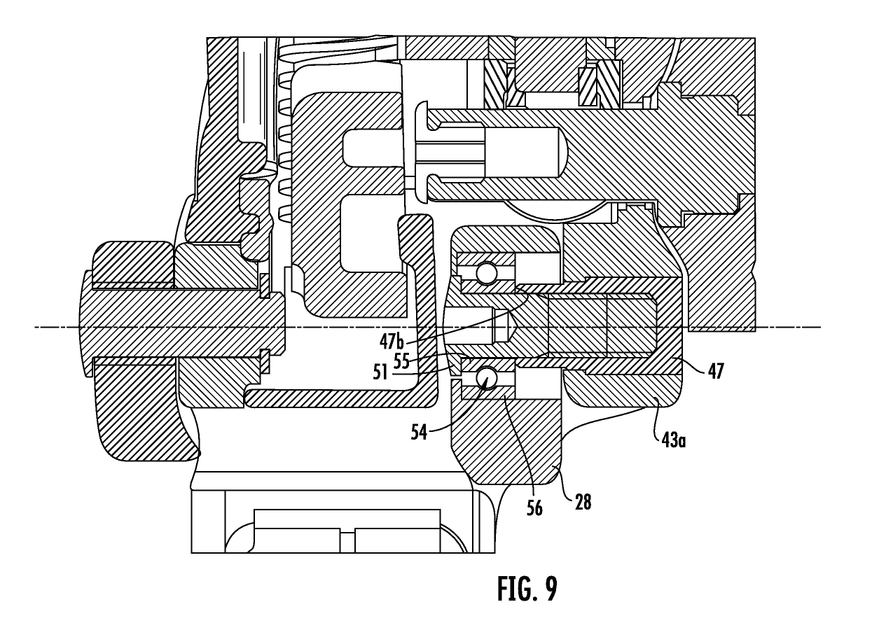

FIG. 9 shows a fifth embodiment of the bicycle gearshift. In this embodiment, structural elements that are identical or equivalent from the functional point of view to those of the gearshift 20 described above with reference to FIGS. 1-5 shall be indicated with the same reference numerals and they shall not be described any further.

This fifth embodiment of the gearshift differs from the first embodiment of the gearshift 20 in that the disc spring 60 and the axial bearing 62 have been omitted. The radial bearing 54 is provided and includes the inner ring 55 locked between the head of the pin 51 and the side end 47b of the insert 47, whereas the outer ring 56 is rigidly fixed to the rear articulation arm 28.

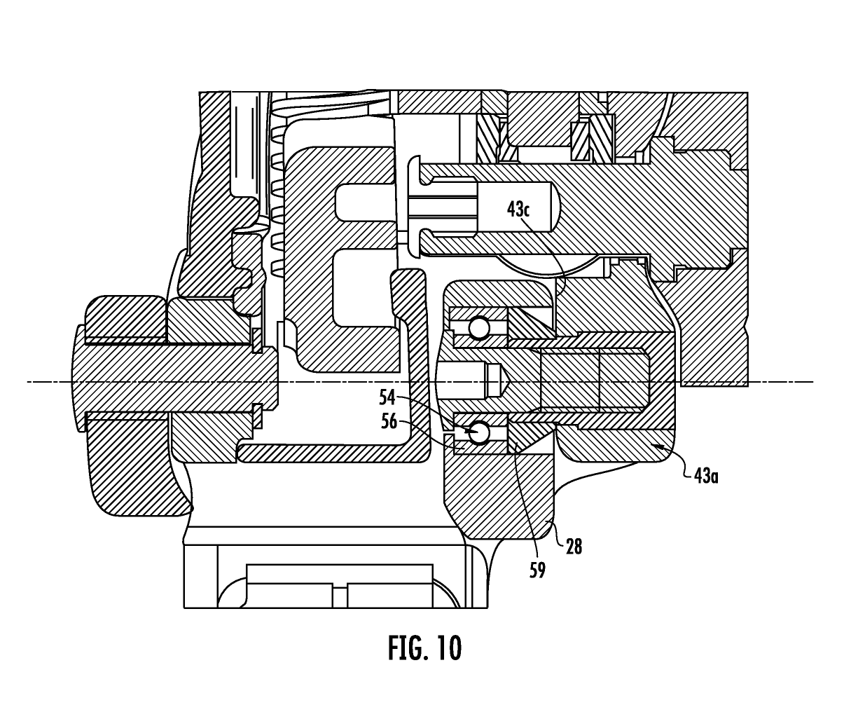

FIG. 10 shows a sixth embodiment of the bicycle gearshift. In this embodiment, structural elements that are identical or equivalent from the functional point of view to those of the gearshift described above with reference to FIG. 9 shall be indicated with the same reference numerals and they shall not be described any further.

This sixth embodiment of the gearshift differs from the embodiment of FIG. 9 in that an elastic pad 59, made from a material such as rubber, has been added between the radial bearing 54 and the side surface 43c of the flange 43a facing the articulation arm 28, to absorb axial loads and to provide a support that completely eliminates the axial clearances.

The pad 59 has an annular shape and is mounted outside the insert 47. The radius of the pad 59 decreases in a direction approaching the flange 43a.

The sliding friction between the pad 59 and the outer ring 56 is relatively low under typical operating conditions since the contact surface is limited and the load transmitted by the driving member is mainly directed in the radial direction.

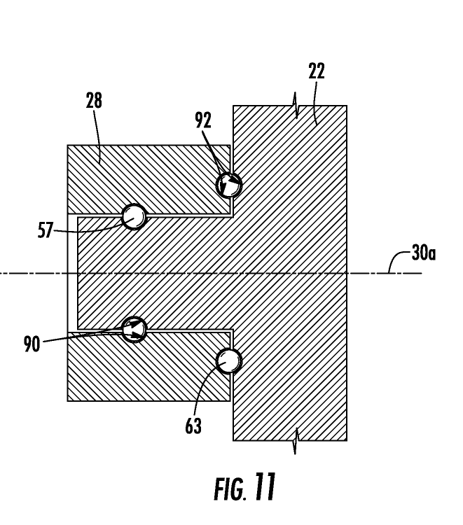

FIG. 11 shows a seventh embodiment of the bicycle gearshift. In this embodiment, structural elements that are identical or equivalent from the functional point of view to those of the gearshift 20 described above with reference to FIG. 1-5 shall be indicated with the same reference numerals and they shall not be described any further.

This seventh embodiment of the gearshift differs from the first embodiment of the gearshift 20 in that the bearings 54 and 62 with rings for the radial and axial supports are respectively replaced by the rolling elements 57 and 63 that are arranged between the support member 22 and the articulation arm 28. The rolling elements 57 and 63 slide on respective circumferential pathways 90 and 92 defined in the support member 22 and the articulation arm 28.

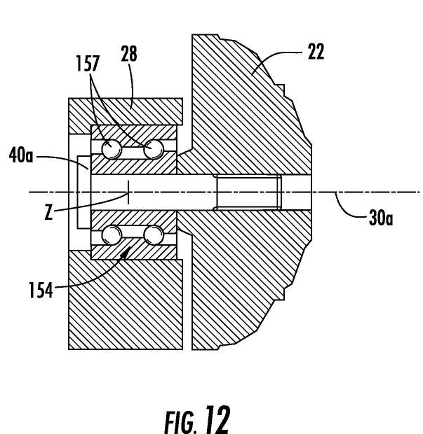

FIG. 12 shows an eighth embodiment of the bicycle gearshift. In this embodiment, structural elements that are identical or equivalent from the functional point of view to those of the gearshift 20 described above with reference to FIG. 1-5 shall be indicated with the same reference numerals and they shall not be described any further.

This eighth embodiment of the gearshift differs from the first embodiment of the gearshift 20 substantially in that the radial bearing 54 and the axial bearing 62 are replaced by a single bearing 154, which has the functional characteristics of the two bearings 54 and 62. The bearing 154 includes a double row of balls 157 that simultaneously provide support both in the radial and axial directions, and prevent the bearing 154 from pitching, i.e. from rotating about an axis Z perpendicular to the axis 30a.

In this embodiment, the pin 40a is directly screwed into the support member 22 without interposition of the insert 47.

Although the gearshift has up to now been described and illustrated with reference to a front gearshift of a bicycle, a person of ordinary skill in the art would understand that it can also be easily applied to a rear gearshift while imparting the same advantages.

Moreover, although the gearshift has been described with reference to a motorized gearshift, a person of ordinary skill in the art would understand that it can also be easily applied to a manual gearshift.

Moreover, although the elements of the gearshift have been described and illustrated with reference to the articulation between the support member 22 and the rear articulation arm 28, they can be applied to any pair of components that rotate with respect to one another about a common axis and belong to the articulated quadrilateral formed by the support member 22, the driving member 24, the front articulation arm 26 and the rear articulation arm 28.

A person of ordinary skill in the art could envision numerous modifications and variants to the bicycle gearshift described above, in order to satisfy specific and contingent requirements, all of which are covered by the scope of protection of the following claims.

For example, the shape and the number of bearings used in the bicycle gearshift can vary, within limits that respect the functional characteristics indicated above.

What is claimed is:

1. A bicycle gearshift (20), comprising a support member (22) configured to be mounted on a bicycle frame, a driving member (24) that drives a bicycle chain, and at least one articulation arm (26, 28) to movably connect said driving member (24) to said support member (22), said at least one articulation arm (26, 28) being connected to at least one portion of said support member (22) and said driving member (24) so that it rotates around a respective rotational axis (30a, 30b, 30c, 30d) through at least one respective connecting pin (37, 38, 40a, 40b, 41a, 41b) extending along said rotational axis (30a, 30b, 30c, 30d), the gearshift comprising at least one first rolling element (57) operatively arranged in the radial direction between said at least one connecting pin (37, 38, 40a, 40b, 41a, 41b), one of said at least one articulation arms (26, 28) and said at least one portion of said support member (22), or said driving member (24).

2. The gearshift (20) of claim 1, wherein said at least one connecting pin (37, 38, 40a, 40b, 41a, 41b) is associated with said at least one portion of said support member (22) or said driving member (24), and said at least one first rolling element (57) is arranged between said at least one connecting pin (37, 38, 40a, 40b, 41a, 41b) and said at least one articulation arm (26, 28).

3. The gearshift (20) of claim 2, wherein said at least one connecting pin (37) is formed as one piece with said at least one portion of said support member (22) or said driving member.

4. The gearshift (20) of claim 2, wherein said at least one connecting pin (37, 38, 40a, 40b, 41a, 41b) is removably associated with said at least one portion of said support member (22) or said driving member (24).

5. The gearshift (20) of claim 1, wherein said at least one connecting pin (37, 38, 40a, 40b, 41a, 41b) is associated with said at least one articulation arm (26, 28), and said at least one first rolling element (57) is arranged between said at least one connecting pin (37, 38, 40a, 40b, 41a, 41b) and said at least one portion of said support member or said driving member.

6. The gearshift (20) of claim 5, wherein said at least one connecting pin is formed as one piece with said at least one articulation arm.

7. The gearshift (20) of claim 5, wherein said at least one connecting pin (37, 38, 40a, 40b, 41a, 41b) is removably associated with said at least one articulation arm (26, 28).

8. The gearshift (20) of claim 1, wherein said at least one articulation arm (26, 28), and at least one portion of said support member (22) or said driving member (24) rest directly on one another in the axial direction.

9. The gearshift (20) of claim 1, wherein said at least one articulation arm (26, 28) and at least one portion of said support member (22) or said driving member (24) rest on one another in the axial direction through the interposition of at least one second rolling element (63).

10. The gearshift (20) of claim 1, further comprising at least one setting device (51) that exerts a preloading force in the axial direction on said at least one articulation arm (26, 28), said at least one portion of said support member (22) or said driving member (24).

11. The gearshift (20) of claim 1, further comprising at least one elastic element (59, 60, 160) operatively arranged between said at least one articulation arm (26, 28), said at least one portion of said support member (22), or said driving member (24), to exert a biasing force in the axial direction on said at least one articulation arm (26, 28), and said at least one portion of said support member (22) or said driving member (24).

12. The gearshift (20) of claim 11, wherein said at least one elastic element (59, 60, 160) is arranged between said at least one first rolling element (57), said at least one articulation arm (26, 28), and said at least one portion of said support member (22) or said driving member (24).

13. The gearshift (20) of claim 9, further comprising at least one setting device (51) that exerts a preloading force in the axial direction on said at least one articulation arm (26, 28), and said at least one portion of said support member (22) or said driving member (24), further comprising at least one elastic element (59, 60, 160) operatively arranged between said at least one articulation arm (26, 28), said at least one portion of said support member (22), or said driving member (24), to exert a biasing force in the axial direction on said at least one articulation arm (26, 28), and said at least one portion of said support member (22), or said driving member (24), wherein said at least one elastic element (60) is arranged between said at least one first rolling element (57) and said at least one second rolling element (63) and between said at least one articulation arm (26, 28), and said at least one portion of said support member (22) or said driving member (24).

14. The gearshift (20) of claim 9 further comprising at least one elastic element (59, 60, 160) operatively arranged between said at least one articulation arm (26, 28), and said at least one portion of said support member (22), or said driving member (24), to exert a biasing force in the axial direction on said at least one articulation arm (26, 28), and said at least one portion of said support member (22) or said driving member (24), wherein said at least one elastic element (160) is also arranged between said at least one second rolling element (63) and said at least one articulation arm (26, 28) and said at least one portion of said support member (22) or said driving member (24).

15. The gearshift (20) of claim 11, wherein said at least one elastic element (60, 160) comprises a disc spring.

16. The gearshift (20) of claim 2, wherein said at least one connecting pin (37, 38, 40a, 40b, 41a, 41b) is rigidly fixed to said at least one portion of said support member (22) or said driving member (24).

17. The gearshift (20) of claim 16, wherein said at least one connecting pin (40a, 41b) is screwed into at least one threaded cavity of said at least one portion of said support member (22) or said driving member (24).

18. The gearshift (20) of claim 16, wherein said at least one connecting pin is screwed into at least one threaded cavity (47c) of at least one insert (47, 147) associated with said at least one portion of said support member (22) or said driving member (28).

19. The gearshift (20) of claim 1, wherein said at least one first rolling element (57) is in a radial bearing (54).

20. The gearshift (20) of claim 19, wherein said radial bearing (54) comprises an inner ring (55) fitted onto said at least one connecting pin (37, 38, 40a, 40b, 41a, 41b) and an outer ring (56) associated with the inside of at least one cavity (52) of said at least one articulation arm (26, 28) or of said at least one portion of said support member (22) or said driving member (24).

21. The gearshift (20) of claim 20, wherein said at least one connecting pin (37, 38, 40a, 40b, 41a, 41b) comprises a head (51) in axial abutment with said inner ring (55) of said radial bearing (54).

22. The gearshift (20) of claim 9, wherein said at least one second rolling element (63) is comprised in an axial bearing (62).

23. The gearshift (20) of claim 22, wherein said axial bearing (62) is operatively arranged between the outer ring (56) of said radial bearing (54) and one of said at least one articulation arms (26, 28) and said at least one portion of said support member (22) or said driving member (24).

24. The gearshift (20) of claim 22, wherein said axial bearing (62) has a first ring (64) adjacent to the radial bearing (54) mounted with clearance on said at least one connecting pin (37, 38, 40a, 40b, 41a, 41b) and a second ring (66) opposite said first ring (64) mounted with clearance on said at least one articulation arm (26, 28) or on said at least one portion of said support member (22) or said driving member (24).

25. The gearshift (20) of claim 9, wherein said at least one first rolling element (57) and said at least one second rolling element (63) are comprised in a single bearing (154) having a double row of rolling elements (157).

26. The gearshift (20) of claim 1, further comprising first circumferential pathways (90) defined in said at least one connecting pin (37, 38, 40a, 40b, 41a, 41b) and in said at least one articulation arm (26, 28) or at least one portion of said support member (22) or driving member (24), to permit rolling of said at least one first rolling element (57).

27. The gearshift (20) of claim 1, further comprising second circumferential pathways (92) defined in said at least one articulation arm (37, 38, 40a, 40b, 41a, 41b) and in said at least one portion of said support member (22) or driving member (24), to permit rolling of at least one second rolling element (63).

28. The gearshift (20) of claim 1, further comprising two articulation arms (26, 28), wherein said at least one first rolling element (57) is coupled with one of the two articulation arms (28) that is closest to a bicycle frame when the gearshift (20) is associated with the frame.

29. The gearshift (20) of claim 28, wherein said at least one first rolling element (57) is coupled with said articulation arm (28) at a portion of said articulation arm (28) which is axially farthest away from a driving portion (25) of said driving member (24).

30. The gearshift (20) of claim 1, wherein said gearshift is a motorized gearshift (20).

31. The gearshift (20) of claim 1, wherein said gearshift is a manually actuated gearshift.

32. A bicycle comprising a gearshift (20), the gearshift comprising a support member (22) configured to be mounted on a bicycle frame, a driving member (24) that drives a bicycle chain and at least one articulation arm (26, 28) to movably connect said driving member (24) to said support member (22), said at least one articulation arm (26, 28) being connected to at least one portion of said support member (22) and said driving member (24) so that it rotates around a respective rotational axis (30a, 30b, 30c, 30d) through at least one respective connecting pin (37, 38, 40a, 40b, 41a, 41b) extending along said rotational axis (30a, 30b, 30c, 30d), the gearshift comprising at least one first rolling element (57) operatively arranged in the radial direction between said at least one connecting pin (37, 38, 40a, 40b, 41a, 41b), one of said at least one articulation arms (26, 28) and said at least one portion of said support member (22), or said driving member (24).

33. A shifter (20), for controlling the position of a bicycle chain, the shifter comprising:
a support member (22) configured to be mounted on a bicycle frame about a chain;
a driving member (24);
an articulation arm (26, 28) that movably connects the driving member (24) to the support member (22);
a plurality of connecting pins (37, 38, 40a, 40b, 41a, 41b) that connect the support member (22), driving member (24), and the articulation arm (26, 28); and
at least one first rolling element (57) mounted about a rotational axis (30a, 30b, 30c, 30d) at a radially outer position with respect to a connecting pin (37, 38, 40a, 40b, 41a, 41b).

34. A bicycle gearshift (20), comprising:
a plurality of members (22, 24, 26, 28) attached by connecting pins (37, 38, 40a, 40b, 41a, 41b) associated with respective rotational axes (30a, 30b, 30c, 30d) to form an articulated quadrilateral; and
a rolling element (57) mounted at a radially outer position with respect to a connecting pin (37, 38, 40a, 40b, 41a, 41b).

35. A gearshift (20), for selecting the position of a bicycle chain, the gearshift comprising:
a support member (22) mountable on a bicycle frame;
a driving member (24);
articulation arms (26, 28);
connecting pins (37, 38, 40a, 40b, 41a, 41b) that form the support member (22), the driving member (24) and the articulation arms (26, 28) into a quadrilateral, such that the driving member (24) rotates around a respective rotational axis (30a, 30b, 30c, 30d); and
first and second rolling elements (57, 62) arranged in the radial direction between at least one of the connecting pins (37, 38, 40a, 40b, 41a, 41b) and a selected one of the articulation arms (26, 28), support member (22) and driving member (24).

36. A bicycle gearshift (20), comprising:
a support member (22) configured to be mounted on a bicycle frame;
a driving member (24) that drives a bicycle chain; and
at least one articulation arm (26, 28) to movably connect the driving member (24) to the support member (22);
wherein the at least one articulation arm (26, 28) is connected to at least one portion of each of the support member (22) and the driving member (24) so that it rotates around respective rotational axes (30a, 30b, 30c, 30d) through at least one respective connecting pin (37, 38, 40a, 40b, 41a, 41b) extending along the rotational axis (30a, 30b, 30c, 30d); and
the at least one articulation arm (26, 28) and at least one portion of the support member (22) or the driving member rest on one another in the axial direction through the interposition of at least one radial bearing (54) comprising a first rolling element (57) and at least one axial bearing (62) comprising a second rolling element (63);
the bearings (54, 62) being mounted about the rotational axis (30a, 30b, 30c, 30d), at radially outer positions with respect to a connecting pin (37, 38, 40a, 40b, 41a, 41b).

37. A bicycle gearshift (20), comprising:
a support member (22) configured to be mounted on a bicycle frame;
a driving member (24) that drives a bicycle chain; and
at least one articulation arm (26, 28) that movably connects the driving member (24) to the support member (22);
wherein the at least one articulation arm (26, 28) is connected to at least one portion of the support member (22) and the driving member (24) so that it rotates around a respective rotational axis (30a, 30b, 30c, 30d) through at least one respective connecting pin (37, 38, 40a, 40b, 41a, 41b) extending along the rotational axis (30a, 30b, 30c, 30d); and
the at least one articulation arm (26, 28) and at least one portion of the support member (22) or the driving member rest on one another in the axial direction through the interposition of at least one radial bearing (54) comprising a first rolling element (57), at least one axial bearing (62) comprising a second rolling element (63), and at least one elastic element (59, 60, 160) interposed between the bearings (54, 62);
the bearings (54, 62) and elastic element (59, 60, 160) each being mounted about the rotational axis (30a, 30b, 30c, 30d), at radially outer positions with respect to a connecting pin (37, 38, 40a, 40b, 41a, 41b).

38. A bicycle gearshift (20) comprising:
a support member (22) configured to be mounted on a bicycle frame;
a driving member (24) that drives a bicycle chain; and
first and second articulation arms (26, 28) located at different distances from the bicycle frame that are pivotally connected to at least one portion of each of the support member (22) and the driving member (24) about respective rotational axes (30a, 30b, 30c, 30d) to form an articulated quadrilateral arrangement; and
the second articulation arm (28) and at least one portion of the support member (22) or the driving member (24) are axially stacked through the interposition of at least one radial bearing (54) comprising a first rolling element (57) and at least one axial bearing (62) comprising a second rolling element (63), each of the bearings being associated a portion of the second articulation arm (28);
the bearings (54, 62) are mounted about the rotational axis (30a, 30b, 30c, 30d), at radially outer positions with respect to a connecting pin (37, 38, 40a, 40b, 41a, 41b).

39. A motorized shifter (20), for controlling the position of a bicycle chain, the shifter comprising:
a support member (22) configured to be mounted on a bicycle frame about a chain and shaped to house a worm screw (32) actuated by an electric motor (35);
a driving member (24);
an articulation arm (26, 28) that connects the driving member (24) to the support member (22) and engages the worm screw (32);
a plurality of connecting pins (37, 38, 40a, 40b, 41a, 41b) that connect the support member (22), driving member (24), and the articulation arm (26, 28) to form an articulated quadrilateral; and
at least one rolling element (57) mounted about a rotational axis (30a, 30b, 30c, 30d).

40. A motorized shifter for a bicycle, the shifter (20) comprising:
a support member (22) configured to mount on a bicycle frame adjacent to a bicycle chain;
a drive member (24);
articulation arms (26, 28), at least one of which has an extension (27);
a plurality of connecting pins (37, 38, 40a, 40b, 41a, 41b) that join the support member (22), drive member (24) and articulation arms (26, 28) into an articulated quadrilateral that houses a motor driven worm screw (32) that engages the extension (27); and
at least one rolling element (57) positioned between a selected one of the connecting pins (37, 38, 40a, 40b, 41a, 41b) and a selected one of the articulated quadrilateral elements (22, 24, 26, 28).
